(19) United States
(12) Patent Application Publication
(10) Pub. No.: US 2007/0270316 A1
(43) Pub. Date: Nov. 22, 2007

(54) Aqueous alcohol well treatment fluid and method of using the same

(75) Inventors: Nabil A. El Shaari, Bakersfield, CA (US); Jeffrey C. Dawson, Conroe, TX (US)

Correspondence Address: JONES & SMITH , LLP, 2777 ALLEN PARKWAY, SUITE 800, HOUSTON, TX, 77019, US

(73) Assignee: BJ Services Company

(21) Appl. No.: 11/729,672

(22) Filed: Mar. 29, 2007

Related U.S. Application Data
(60) Provisional application No. 60/801,569, filed on May 18, 2006.

(51) Int. Cl. C09K 8/60; E21B 43/27

(52) U.S. Cl. 507/201

(57) ABSTRACT

An aqueous alcohol-containing well treatment fluid containing a polysaccharide derivative as gelling agent, optionally crosslinked, is capable of being degraded at elevated temperatures by the presence of an enzyme and an organic acid ester. The well treatment fluid has particular applicability in the treatment of low pressure gas producing wells.

This application claims the benefit of U.S. patent application Ser. No. 60/801,569, filed on May 18, 2006.

### FIELD OF THE INVENTION

The invention relates to an aqueous alcohol well treatment fluid which contains an enzyme and an organic acid ester and a method of using the fluid in the treatment of an oil or gas well.

### BACKGROUND OF THE INVENTION

Hydraulic fracturing of oil and gas wells is a technique routinely used to improve or stimulate the recovery of hydrocarbons, and is typically used to stimulate low permeability subterranean formations. In practice, recovery efficiency is typically limited by the flow mechanisms associated with low permeability formations. Hydraulic fracturing is usually accomplished by injecting a fluid, typically proppant-laden, into a producing interval at a pressure above the fracturing pressure of the subterranean formation. This fluid induces a fracture in the reservoir and transports proppant into the fracture before leaking off into the surrounding formation. After the treatment, proppant remains in the fracture in the form of a permeable pack that serves to prop the fracture open. In this way the proppant path forms a conductive pathway for hydrocarbons to flow into the wellbore.

Typically, viscous gels are employed as fracturing fluids in order to provide a medium that will adequately suspend and transport solid proppant materials, as well as to impair loss of fracture fluid to the formation during the treatment. Fracture width and geometry are determined, in part, by the viscosity of the fracturing fluid. Viscosity of most water-based fracturing fluids is typically obtained from water-soluble polymers such as guar gums, guar derivatives, and cellulose derivatives.

An important attribute of any fracturing fluid is its ability to exhibit reduced viscosity after injection, particularly in a manner that minimizes fracture damage due to residual polymer. Typically, breakers are used to reduce viscosity.

Further enhancement of fracturing fluid viscosity may be obtained by treating polymeric solutions with cross-linking agents, typically selected from titanium, aluminum, boron and zirconium based compounds, or mixtures thereof. Crosslinked synthetic polymer gels are able to withstand the high temperature conditions commonly found in deeper oil and gas wells. Organometallic compounds are often used as a crosslinking agent in these polymer gels. However, these polymers, even after the reduction in viscosity, produce residue in sufficient amounts to damage the formation.

One of the least damaging crosslinked fracturing fluids is the system composed of galactomannan polysaccharides (such as guar gum and its derivatives, including hydroxypropyl guar (“HPG”), carboxymethyl guar (“CMG”) and carboxymethylhydroxypropyl guar (“CMHPG”)) which has been crosslinked, at high pH, with borate ions.

Most typically, boron crosslinkers are employed with guar because it offers suitable performance at lower cost. In recent years, the concentration of guar gum has steadily declined due to means for improving the viscosity to mass ratio.

Guar based fracturing fluids however are incompatible in aqueous alcohol fluids. Aqueous fluids, such as aqueous methanol, ethanol and isopropanol fluids, are especially useful in the treatment of gas wells since they are known to enhance recovery in light of its ability to increase vapor pressure and reduce surface tension of the fracturing fluid. The use of aqueous alcohol fluids in the treatment of wells has also become highly desirable to minimize damage to the subterranean formation.

Since guar gum is typically not soluble in aqueous alcohol fluids, efforts have been undertaken to replace guar gum with guar derivatives such as CMHPG. Unfortunately, conventional breakers are ineffective in the presence of aqueous fluids containing high levels of alcohol. A solution has therefore been sought for a fluid capable of being used in a gas well containing CMHPG and an aqueous alcohol fluid.

### SUMMARY OF THE INVENTION

An aqueous alcohol well treatment fluid which exhibits the ability to degrade at elevated temperatures contains a polysaccharide derivative gelling agent, an enzyme and an organic acid ester. In a preferred embodiment, the gelling agent is crosslinked. The alcohol is methanol, ethanol, isopropanol or a mixture thereof. The well treatment fluid has particular applicability in the treatment of gas wells, such as a fracturing fluid for the treatment of gas wells.

The hydratable gelling agent is preferably a polysaccharide derivative, such as carboxymethyl hydroxyethyl cellulose (CMHEC), hydroxyethyl cellulose (HEC), carboxymethyl cellulose (CMC), carboxymethyl guar (CMG), carboxymethyl hydroxypropyl guar (CMHPG) and hydroxypropyl guar (HPG). CMHPG is preferred. The gelling agent is crosslinked preferably with either a borate ion releasing compound or an organometallic or organic complexed metal ion comprising Zr (IV).

Preferred enzyme breakers are those which are able to break the backbone of the gel into monosaccharide and disaccharide fragments and include those enzymatic breakers such as guar specific enzymes, alpha and beta amylases, amyloglucosidase, aligoglucosidase, invertase, maltase, cellulase, and hemi-cellulases. Preferred enzyme breakers are galactomannases, cellulases and hemicellulases.

The organic acid esters are preferably multi-carboxylated and derived from at least one C₁-C₆ primary or secondary alcohol. Preferred esters include those made from oxalic, fumaric, succinic, phthalic and ethylenediaminetetraacetic acid or which may contain one or more optional substituents, such as hydroxyl and especially triethylcitrate.

The organic acid ester is capable of decreasing the pH of the well treatment fluid which, in turn, causes an increase in enzymatic activity, thereby resulting in the degradation of the polymeric gelling agent of the treatment fluid.

### BRIEF DESCRIPTION OF THE DRAWINGS

In order to more fully understand the drawings referred to in the detailed description of the present invention, a brief description of each drawing is presented, in which:

FIGS. 1, 2 and 3 are apparent viscosity profiles of a treatment fluid containing an enzyme and an organic acid ester in an aqueous alcohol fluid tested at 100° F., 115° F. and 130° F., respectively, as discussed in the Examples.

### DETAILED DESCRIPTION OF THE PREFERRED EMBODIMENTS

The invention relates to the use of an aqueous alcohol based treatment fluid containing a gelling agent, an enzyme and an organic acid ester. The treatment fluid is capable of being degraded under downhole conditions. In particular, the degradation of the treatment fluid is attributable to the combination of the organic acid ester and an enzyme. In addition, the combination is capable of minimizing fracture damage and thereby maximize hydrocarbon production. The well treatment fluid finds particular applicability in the treatment of low pressure gas producing wells. In addition, the well treatment fluid of the invention has applicability in the treatment of oil wells as well as injector wells and geothermal wells.

The base solution of the treatment fluid is aqueous methanol, ethanol, isopropanol or a mixture thereof. In a preferred embodiment, the base solution is aqueous methanol. The alcohol is present in concentrations sufficient for the treatment fluid to be effective in the treatment of the well being treated. Typically, the amount of the aqueous alcohol in the treatment fluid is between from about 95 to about 98 weight percent and the percent of alcohol in the aqueous alcohol is typically between from about 5 to about 75, preferably from about 8 to about 40, most preferably from about 10 to about 25, volume percent.

The gelling agent is hydratable in the aqueous alcohol and is preferably a poylsaccharide derivative, such as carboxymethyl hydroxyethyl cellulose (CMHEC), hydroxyethyl cellulose (HEC), carboxymethyl cellulose (CMC) or a guar derivative like carboxymethyl guar (CMG), carboxymethyl hydroxypropyl guar (CMHPG) or hydroxypropyl guar (HPG). Suitable polymers include those available from BJ Services Company as “GW21” (HEC), “GW45” (CMG), “GW28” (CMHEC), “GW32” (HPG) and “GW38” (CMHPG). Slurried counterparts of these polymers may also be used and are available from BJ Services Company as “XLFC2” (HPG), “XLFC2B” (HPG), “XLFC3” (CMPHG) “XLFC3B” (CMHPG), “VSP1” (CMG), and “VSP2” (CMG). A most preferred polysaccharide gelling agent is CMHPG, though CMG and HPG, also soluble in alcohol, are also preferred. The CMHPG is most preferred due to its ease of hydration, availability and tolerance to hard water.

Further preferred as guar derivatives are hydroxyalkylated guars like hydroxypropyl guar, hydroxyethyl guar and hydroxybutyl guar and modified hydroxyalkylated guars like carboxymethylhydroxypropyl guar, preferably those having a molecular weight of about 1 to about 3 million. The carboxyl content of the hydratable polysaccharides is expressed as Degree of Substitution (“DS”) and ranges from about 0.08 to about 0.18 and the hydroxypropyl content is expressed as Molar Substitution (MS) (defined as the number of moles of hydroxyalkyl groups per mole of anhydroglucose) and ranges between from about 0.2 to about 0.6.

Typically, the amount of gelling agent employed is between from about 15 to about 50, preferably from about 20 to about 30, pounds per 1,000 gallons of aqueous alcohol.

The gelling agents may be crosslinked in order to withstand the high temperature conditions commonly found in deeper oil and gas wells with little reduction in viscosity. The hydratable polymers are typically buffered to pH values extending from 8.5 to 12.0, preferably from 9.5 to 10.5, in order to effectuate borate crosslinking. Conventional buffering agents such as potassium carbonate may be employed for this purpose.

The crosslinking agent, when used, preferably comprises a borate ion releasing compound, an organometallic or organic complexed metal ion comprising at least one transition metal or alkaline earth metal ion as well as mixtures thereof, such as Zr (IV) and Ti (IV). Such crosslinking agents significantly enhance the viscosity of the fluid and converts it from a solution to a three dimensional gel.

Borate crosslinkers are especially preferred. Preferred borate crosslinkers include those disclosed in U.S. Pat. Nos. 5,145,590 and 5,082,579, herein incorporated by reference. Further borate ion releasing compounds which can be employed include, for example, any boron compound which will supply borate ions in the composition, for example, boric acid, alkali metal borates such as sodium diborate, potassium tetraborate, sodium tetraborate (borax), pentaborates and the like and alkaline and zinc metal borates. Such borate ion releasing compounds are disclosed in U.S. Pat. No. 3,058,909 and U.S. Pat. No. 3,974,077 herein incorporated by reference. In addition, such borate ion releasing compounds include boric oxide (such as selected from H₃BO₃ and B₂O₃) and polymeric borate compounds. An example of a suitable polymeric borate compound is a polymeric compound of boric acid and an alkali borate which is commercially available under the trademark POLYBOR® from U.S. Borax of Valencia, Calif. Mixtures of any of the referenced borate ion releasing compounds may further be employed. Such borate-releasers typically require a basic pH (e.g., 7.0 to 12) for crosslinking to occur. A particularly preferred polysaccharide derivative is the reaction product of a guar derivative and a borate crosslinking agent.

Further preferred crosslinking agents are reagents, such as organometallic and organic complexed metal compounds, which can supply zirconium IV ions such as, for example, zirconium lactate, zirconium lactate triethanolamine, zirconium carbonate, zirconium acetylacetonate and zirconium diisopropylamine lactate; as well as compounds that can supply titanium IV ions such as, for example, titanium ammonium lactate, titanium triethanolamine, and titanium acetylacetonate. Zr (IV) and Ti (IV) may further be added directly as ions or oxy ions into the composition.

Further suitable as crosslinking agents are organometallic and organic complexed metal crosslinking agents containing titanium or zirconium in a +4 valence state including those disclosed in British Pat. No. 2,108,122, herein incorporated herein by reference, which are prepared by reacting zirconium tetraalkoxides with alkanolamines under essentially anhydrous conditions. Other zirconium and titanium crosslinking agents are described, for example, in U.S. Pat. No. 3,888,312; U.S. Pat. No. 3,301,723; U.S. Pat. No. 4,460,751; U.S. Pat. No. 4,477,360; European Pat. No. 92,755; and U.S. Pat. No. 4,780,223, all of which are herein incorporated by reference. Such organometallic and organic complexed metal crosslinking agents containing titanium or zirconium in a +4 oxidation valance state may contain one or more alkanolamine ligands such as ethanolamine (mono-, di- or triethanolamine) ligands, such as bis(triethanolamine)bis(isopropyl)-titanium (IV).

Typically, the crosslinking agent, when used, is employed in the treatment fluid in a concentration of from about 0.001 percent to about 2 percent, preferably from about 0.005 percent to about 1.5 percent, and, most preferably, from about 0.01 percent to about 1.0 percent. As such, the fluid is weakly crosslinked, partly due to the high alcohol concentration of the fluid.

Since the oxidative breakers are not as efficient in aqueous alcohol solutions, they are not capable of fully reducing the viscosity of the fluid in a controlled manner. The rate of polymer degradation is normally controlled in part by the breaker concentration. Unfortunately, the oxidative breakers are used at concentrations that either promote premature degradation, ending treatment prematurely, or provide incomplete degradation. The well treatment fluid of the invention contains, as degradative agent and/or breaker, the combination of an enzyme and an organic acid ester. As such, degradation of the polymeric gelling agent is easily controlled in the alcohol-rich treatment fluid. The combination of the organic acid ester and the enzyme causes viscosity reduction of the gelling agent and thereby subsequent polymer degradation.

The enzyme breaker is one or more enzymes which is capable of degrading the backbone of the gelling agent. The preferred enzyme breakers of the invention, such as hydrolases, are stable in the desired pH range from about 4.0 to 11.0 and remain functional at a pH above about 8.0, with maximum activity at a decreased pH, generally between from about 5.0 to about 7.0. The same enzymes are functional at low to high temperatures of about 50° F. to about 275° F. and above.

Preferred enzyme breakers are those which are able to break the backbone of the gel into monosaccharide and disaccharide fragments and include those enzymatic breakers such as guar specific enzymes, alpha and beta amylases, amyloglucosidase, aligoglucosidase, invertase, maltase, cellulase, and hemi-cellulases disclosed in U.S. Pat. Nos. 5,806,597 and 5,067,566, herein incorporated by reference. Preferred enzyme breakers are galactomannases, cellulases and hemicellulases.

Typically, the enzyme is introduced as an aqueous enzyme solution. The weight percentage of enzyme solution in the treatment fluid is dependent upon the number of units of enzyme activity in the aqueous enzyme solution. For instance, the amount of an aqueous enzyme solution having 30,000 units of enzyme activity in the treatment fluid is generally between from about 0.05 to about 1.3 weight percent, preferably from about 0.103 to about 0.206 weight percent. The weight percentage of an enzyme solution containing a different unit of enzyme activity may be determined using the designated weight percentage for the enzyme solution containing 30,000 units of enzyme activity.

The organic acid ester is capable of undergoing hydrolysis. The by-products of hydrolysis are increased alcohol and an organic acid. The acid is principally responsible for slowly reducing the pH of the treatment fluid and thereby enabling the enzyme to activate. For instance, hydrolysis of the organic acid ester to render release of the organic acid easily results in a decline in pH from about 10.5 to about 8.7 when the concentration of organic acid ester ranges from about 0.2 to about 0.4% (by volume) in the treatment fluid. Naturally, higher concentrations of organic acid esters may result in further lowering of the pH of the treatment fluid until maximum activity of the enzyme becomes possible, such as at a pH of 5.0 to 7.0.

Suitable ester compounds include those derived from a monocarboxylic or polycarboxylic acid, such as those of the formula R—COOH wherein R is a C₁-C₁₁ alkyl or substituted alkyl group or a phenyl or substituted phenyl group such as, methoxyphenyl. alkylphenyl or carboxylated phenyl. Suitable esters include, but are not limited to, monoesters, diesters, triesters, etc. Suitable esters includes esters of oxalic, malonic, succinic, malic, tartaric, citrate, phthalic, ethylenediaminetetraacetic (EDTA), nitrilotriacetic, and glycolic acid. Specific examples of the alkyl groups originating from the alcohol moiety include, but are not limited to, methyl, ethyl, propyl, butyl, iso-butyl, 2-butyl, t-butyl, benzyl, phenyl, hexyl, pentyl, etc.

Preferred organic acid esters are those that are multi-carboxylated and derived from at least one C₁-C₆ primary or secondary alcohol. The rate of hydrolysis can be adjusted to temperature by selection of the alcohol of the ester. The lower the molecular weight of the alcohol, the more water soluble the ester and the faster the hydrolysis. Preferred esters include those made from oxalic, fumaric, succinic, phthalic and ethylenediaminetetraacetic acid or which may contain one or more optional substituents, such as hydroxyl. The preferred ester is based on triethylcitrate, such as acetyltriethylcitrate. For instance, since citric acid contains a hydroxyl group, the pendent alcohol may be acetylated yielding four moles of acid from each mole of acetyltriethyl citrate.

The well treatment fluid is typically prepared by first hydrating the gelling agent in the aqueous alcohol. The optional crosslinking agent may then be added to generate a viscous fluid. To the viscous fluid may then be added the enzyme and organic acid ester. Where desired, the proppant may further be added. The pumpable fluid may then be introduced into the hydrocarbon-bearing formation.

Alternatively, the well treatment fluid may be prepared by first hydrating the gelling agent in the aqueous alcohol and then adding the pH buffer to the hydrated fluid. The enzyme (relatively inactive at the elevated pH) and organic acid ester may then be introduced to the hydrated gelling agent fluid prior to the addition of the crosslinking agent, when used. A viscous fluid is generated typically almost immediately after the addition of enzyme and organic acid ester. The pumpable fluid, optionally containing proppant, may then be introduced into the hydrocarbon-bearing formation.

The combination of enzyme and organic acid ester is particularly useful in the control in degradation of the polysaccharides. Polymer chains having a molecular weight exceeding 1.5 million to those under 100,0000 may be degraded by use of the combination of enzyme and organic acid ester. This reduction in molecular weight of polymer chains is the principal means of viscosity reduction. The rate of degradation is temperature dependent and can be controlled by the concentrations of both the enzyme and the organic acid ester.

Enzymatic activity is dependent on both temperature and pH. The optimum activity occurs about 100° F. and a pH 5.0. At higher temperatures and pH, the activity decreases, slowing down the rate of polymer hydrolysis. A fluid with a pH in excess of 9.5 are barely exhibit optimum fluid viscosity for proppant placement. Unless the pH is reduced, the fluid remains viscous for periods of time beyond those reasonable for the fracturing treatment.

### EXAMPLES

The following example illustrates clear and controlled breaks of crosslinked CMHPG at different concentrations of organic acid ester and enzyme in aqueous methanol solutions. As such, the example illustrates the practice of the present invention in its preferred embodiment. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### Example

A methanol aqueous fluid was made at ambient temperature by adding 332 pounds of KCl to 1,000 gallons of a blend containing a 25:75 volume ratio of methanol:water. To the resulting blend was then added 25 pounds of CMHPG per 1,000 gallons of the aqueous methanol solution. To the hydrated product was then added 1.1 gallons of a potassium carbonate buffer until the pH was increased to 10.0. 0.8 gallons of a borate crosslinker was then added, the crosslinker prepared by blending 15.9 pounds of boric anhydride per 100 pounds of aqueous methanol fluid. The addition of the borate crosslinker to the polymer solution rendered a highly viscous solution. 2 gallons of aqueous galactomannase solution containing 30,000 units of enzyme activity was then added to the viscous solution along with a designated amount of acetyltriethylcitrate (ATEC) depending on the desired stability of the fluid. The organic acid ester slowly hydrolyzed to become the citric acid which resulted in a drop in the pH of the fluid. The change in pH at a test temperature of 115° F. is set forth in Table I below:

TABLE I

| Time | 2 gpt A TEC, | 4 gpt A TEC, |
|---|---|---|
| (hrs) | pH | pH |
| 0.0 | 10.08 | 9.92 |
| 0.5 | 9.82 | 9.61 |
| 1.0 | 8.96 | 9.06 |
| 1.5 | 8.88 | 8.58 |
| 2.0 | 8.66 | 8.24 |
| 2.5 | 8.51 | 8.07 |
| 3.0 | 8.27 | 7.85 |
| 4.0 | 7.84 | 7.61 |
| 4.5 | 7.84 | 7.60 |
| 5.0 | 7.91 | 7.56 |
| 5.5 | 7.89 | 7.54 |
| 6.0 | 7.85 | 7.50 |
| 23.0 | 7.09 | 6.83 |

The lowering of the pH, in turn, further caused decrease in crosslinking by retarding the rate of conversion of the boron in the crosslinking agent to borate. Thus, the combination of the lowered pH and the increase in the activity of the enzyme caused the breakdown of the CMHPG.

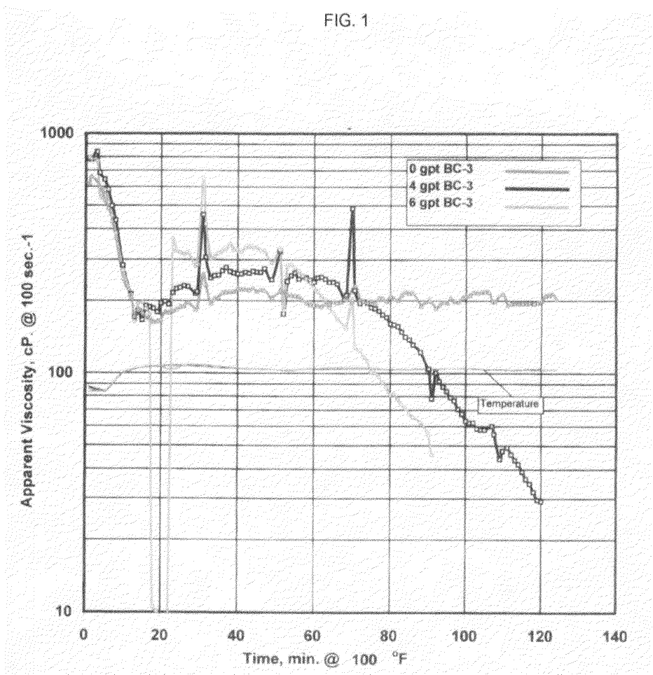

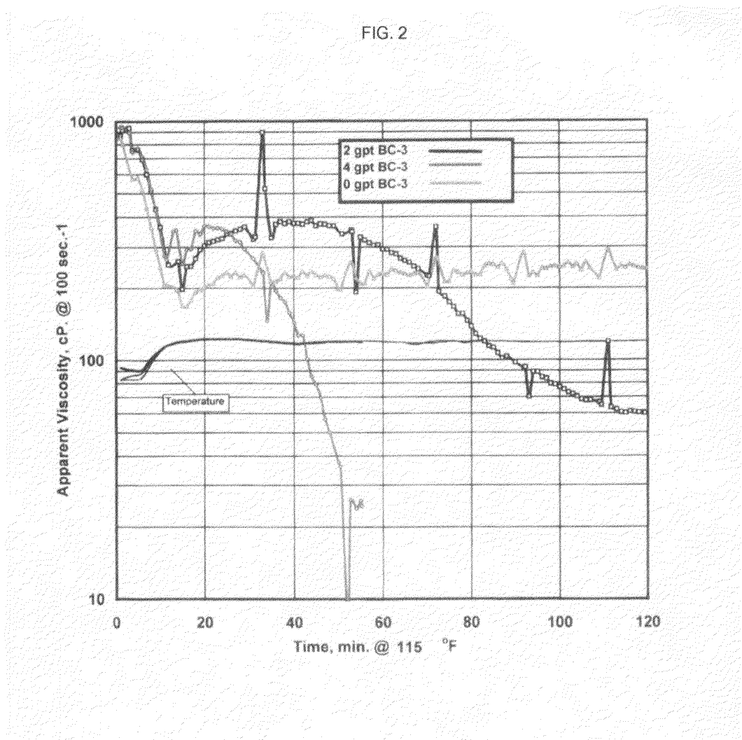

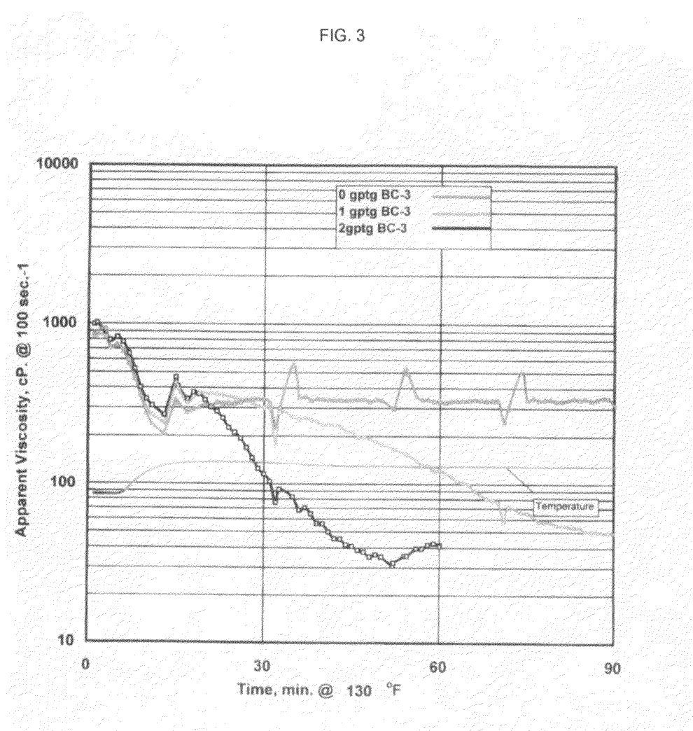

The rheology was measured at 100° F., 115° F. and 130° F. and the apparent viscosity calculated at 100 sec⁻¹ shear rate based on viscosity measured on a Fann35 rheometer (170 sec⁻¹ and 511 sec⁻¹) at the various temperatures. The results are set forth in Tables II, III and IV below for tests conducted at 1000, 115° and 130° F., respectively and as illustrated in FIGS. 1, 2 and 3, respectively:

TABLE II

| | Apparent viscosity, | Apparent viscosity, | Apparent viscosity, |
|---|---|---|---|
| Time, | cP at 100 sec⁻¹ | cP at 100 sec⁻¹ | cP at 100 sec⁻¹ |
| Min. | w/ATEC, 0 gpt | w/ATEC, 4 gpt | w/ATEC, 6 gpt |
| 1.0 | 617 | 782 | 797 |
| 1.5 | 660 | 780 | 782 |
| 4 | 601 | 685 | 538 |
| 10 | 249 | 283 | 270 |
| 12 | 208 | 213 | 211 |
| 29 | 188 | 218 | 286 |
| 32 | 234 | 306 | 420 |
| 49 | 206 | 246 | 291 |
| 51 | 225 | 325 | 329 |
| 68 | 203 | 212 | 153 |
| 71 | 233 | 221 | 128 |
| 88 | 191 | 122 | 63 |
| 90 | 204 | 104 | 55 |
| 108 | 199 | 56 | |
| 110 | 215 | 48 | |

TABLE III

| | Apparent viscosity, | Apparent viscosity, | Apparent viscosity, |
|---|---|---|---|
| Time, | cP at 100 sec⁻¹ | cP at 100 sec⁻¹ | cP at 100 sec⁻¹ |
| Min. | w/ATEC, 0 gpt | w/ATEC, 2 gpt | w/ATEC, 4 gpt |
| 1.0 | 856 | 872 | 946 |
| 1.5 | 808 | 920 | 946 |
| 4 | 576 | 757 | 747 |
| 12 | 206 | 252 | 266 |
| 14 | 198 | 261 | 355 |
| 31 | 204 | 332 | 269 |
| 34 | 279 | 523 | |
| 51 | 198 | 342 | 36 |
| 53 | 259 | 349 | 26 |
| 70 | 204 | 225 | |
| 72 | 270 | 193 | |
| 90 | 210 | 98 | |
| 92 | 285 | 93 | |
| 109 | 221 | 65 | |
| 112 | 290 | 63 | |

TABLE IV

| | Apparent viscosity, | Apparent viscosity, | Apparent viscosity, |
|---|---|---|---|
| Time, | cP at 100 sec⁻¹ | cP at 100 sec⁻¹ | cP at 100 sec⁻¹ |
| Min. | w/ATEC, 0 gpt | w/ATEC, 1 gpt | w/ATEC, 2 gpt |
| 1.0 | 874 | 835 | 994 |
| 1.5 | 887 | 858 | 1018 |
| 4 | 732 | 703 | 793 |
| 13 | 210 | 245 | 270 |
| 15 | 322 | 395 | 409 |
| 33 | 303 | 280 | 92 |
| 35 | 569 | 263 | 83 |
| 52 | 299 | 166 | 32 |
| 54 | 498 | 154 | 36 |
| 72 | 298 | 72 | |
| 74 | 514 | 66 | |
| 88 | | 48 | |
| 90 | | 46 | |

In FIGS. 1, 2 and 3, the apparent viscosity is plotted against time at 100° F., 115° F. and 130° F., respectively, which illustrate the ability of the combination of organic acid ester and enzyme to break down the gelled polymeric system. For instance, as illustrated in FIG. 1, at 100 cP, the fluid is considered to be broken down wherein break for a 2 gallons per thousand (gpt) organic acid ester occurs after 80 minutes. Increased concentration shown by 4 gpt organic acid ester demonstrates greater than 50 minutes to break the fluid.

Thus, the Figures illustrate that the treatment fluid defined herein exhibits a defined viscosity for time periods sufficient to carry proppant as a part of the pumpable fluid into a fracture; the viscosity of the fluid then dissipates.

From the foregoing, it will be observed that numerous variations and modifications may be effected without departing from the true spirit and scope of the novel concepts of the invention.

What is claimed is:

1. A well treatment fluid comprising:
(a) an aqueous alcohol;
(b) a polysaccharide derivative gelling agent;
(c) an enzyme; and
(d) an organic acid ester.

2. The well treatment fluid of claim 1, wherein the polysaccharide derivative is carboxymethylhydroxypropylguar.

3. The well treatment fluid of claim 2, wherein the polysaccharide derivative is crosslinked.

4. The well treatment fluid of claim 3, wherein the polysaccharide derivative is the reaction product of a guar derivative and a borate crosslinking agent.

5. The well treatment fluid of claim 1, wherein the amount of alcohol in the well treatment fluid is between from about 10 to about 25 volume percent.

6. The well treatment fluid of claim 1, wherein the alcohol is methanol, ethanol, isopropanol or a mixture thereof.

7. The well treatment fluid of claim 6, wherein the alcohol is methanol.

8. The well treatment fluid of claim 1, wherein the gelling agent is selected from the group consisting of carboxymethyl hydroxyethyl cellulose, hydroxy cellulose, hydroxyethyl cellulose, carboxymethyl cellulose, carboxymethyl guar, carboxymethyl hydroxypropyl guar and hydroxypropyl guar (HPG).

9. The well treatment fluid of claim 7, wherein the gelling agent is carboxymethylhydroxypropylguar.

10. The well treatment fluid of claim 1, wherein the enzyme is at least one enzyme selected from the group consisting of an alpha or beta amylase, amyloglucosidase, aligoglucosidase, invertase, maltase, cellulase and hemi-cellulase.

11. The well treatment fluid of claim 1, wherein the enzyme is at least one enzyme selected from the group consisting of galactomannases, cellulases and hemicellulases.

12. The well treatment fluid of claim 1, wherein the organic acid ester is multi-carboxylated.

13. The well treatment fluid of claim 12, wherein the organic acid ester is an ester of a carboxylic acid selected from the group consisting of oxalic, fumaric, succinic, citric, phthalic and ethylenediaminetetraacetic.

14. The well treatment fluid of claim 12, wherein the organic acid ester is triethylcitrate or acetyltriethylcitrate.

15. A method of stimulating an oil, gas, injection or geothermal well which comprises introducing into the well the well treatment fluid of claim 1.

16. A method of enhancing the productivity of a low pressure gas producing well which comprises pumping into the well the well treatment fluid of claim 1.

17. A method of enhancing the productivity of a hydrocarbon-bearing formation comprising:
(a) hydrating a guar derivative in an aqueous alcohol;
(b) introducing a borate crosslinking agent to the product of step (a) to generate a viscous fluid;
(c) introducing into the viscous fluid an enzyme and an organic acid ester to render a pumpable fluid;
(d) introducing the pumpable fluid into the hydrocarbon-bearing formation wherein the pH of the fluid decreases upon hydrolysis of the organic acid ester.

18. The method of claim 17, wherein the enzyme and organic acid ester are simultaneously introduced to the viscous fluid.

19. The method of claim 17, wherein the pumpable fluid is introduced in step (d) into a gas producing well.

20. The method of claim 17, wherein the alcohol is methanol, ethanol, isopropanol or a mixture thereof.

21. The method of claim 20, wherein the alcohol is methanol.

22. The method of claim 17, wherein the pumpable fluid further contains a proppant.

23. The method of claim 17, wherein the guar derivative is carboxymethylhydroxypropylguar.

24. The method of claim 17, wherein the enzyme is selected from the group consisting of galactomannases, cellulases and hemicellulases.

25. The method of claim 17, wherein the organic acid ester is an ester of a carboxylic acid selected from the group consisting of oxalic, fumaric, succinic, phthalic, citric and ethylenediaminetetraacetic.

26. A method of enhancing the productivity of a hydrocarbon-bearing formation comprising:
(a) hydrating a guar derivative in an aqueous alcohol;
(b) introducing to the product of step (a) an enzyme and an organic acid ester;
(c) introducing to the product of step (b) a borate crosslinking agent to render a viscous pumpable fluid;
(d) introducing the pumpable fluid into the hydrocarbon-bearing formation wherein the pH of the fluid decreases upon hydrolysis of the organic acid ester.
